(19) United States
(12) Patent Application Publication
(10) Pub. No.: US 2026/0258937 A1
(43) Pub. Date: Sep. 3, 2026

(54) Led Lamp

(71) Applicant: NINGBO SANITY LIGHTING ELECTRICAL APPLIANCE CO., LTD., Zhejiang (CN)

(72) Inventor: Feilong GONG, Zhejiang (CN)

(73) Assignee: NINGBO SANITY LIGHTING ELECTRICAL APPLIANCE CO., LTD., Zhejiang (CN)

(21) Appl. No.: 19/433,013

(22) Filed: Dec. 25, 2025

(30) Foreign Application Priority Data
Sep. 26, 2024 (CN) 2024113485485

(51) Int. Cl. F21V 23/06; F21V 17/10; F21Y 115/10

(52) U.S. Cl. CPC F21V 23/06; F21V 17/105; F21V 17/107; F21Y 2115/10

(57) ABSTRACT

The present invention relates to an LED lamp, comprising: a light source, a driving module for driving the light source to operate and a power supply module for supplying power to the driving module, the power supply module being electrically connected to the driving module; and a connector and an emergency module. The connector and the emergency module are capable of being selectively electrically connected to the driving module, so that the LED lamp has at least two operation states: when the connector is electrically connected to the driving module, an electrical connection is established between the driving module and the light source to drive the light source to operate.

### CROSS-REFERENCE TO RELATED APPLICATIONS

This application is a continuation-in-part of U.S. Patent Application No. 19137017, filed on Jun. 9, 2025, which claims priority to Chinese Patent Application No. 202411348548.5, filed on Sep. 26, 2024, all of which are hereby incorporated by reference in their entirety.

### TECHNICAL FIELD

The present disclosure relates to a technical field of lamps, and in particular to an LED Lamp.

### BACKGROUND

By the existing technology, LED lamps are generally powered by alternating current (abbreviated as ‘AC’, same for all below), so the LED lamps cannot be used once the AC power is cut off. However, with the users' increasing demand for LED lamps, it is required that LED lamps can be used even after the AC power is cut off, thus increasing the application scenarios of LED lamps.

To solve the above technical problem, a Chinese Utility Model CN220108286U (patent No.: ZL202321524986.3) disclosed an LED lamp with an emergency lighting function, wherein the LED lamp comprises an AC power input switch, an LED driving power supply, a main lighting LED lamp, an AC power detection circuit, a switch state detection circuit, a standby power supply module, an emergency lighting lamp and a main control module; an input terminal of the main lighting lamp is connected to an output terminal of the LED driving power supply; a detection terminal of the AC power detection circuit is connected to a secondary stage of a AC power distribution transformer, and a feedback terminal of the AC power detection circuit is connected to the main control module; a detection terminal of the switch state detection circuit is connected to a terminal of the AC power input switch that is connected to the LED driving power supply, and a standby terminal of the switch state detection circuit is connected to the main control module; the standby power supply module is connected to the emergency lighting lamp and the main control module; and, a control terminal of the emergency lighting lamp is connected to the main control module.

Although this LED lamp can effectively avoid the problem that the LED lamp cannot provide the lighting function normally when the AC power is cut off, this lamp has the following limitations: on one hand, this lamp comprises two LED lamps, they are the main lighting lamp and the emergency lighting lamp. The emergency lighting lamp is powered by the standby power supply, and the emergency lighting lamp in the LED lamp is only used in case of emergency, so the utilization is low under normal circumstances, resulting in the waste of resources. On the other hand, even if this LED lamp only comprises the main lighting lamp which is powered by the standby power supply, in this case, the standby power supply needs to be connected to the main lighting lamp through a lead, so that it is difficult to disassemble or assemble the lamp in a time-consuming and labor consuming manner. Therefore, further improvements are needed for LED lamps with the existing technology.

### SUMMARY

It is an object of the present disclosure to provide an LED lamp which is easy to assemble or disassemble and enables a continuous operation of a light source even after the AC power is cut off.

For achieving the above object, the LED lamp comprises a light source having an anode and a cathode; a driving module for driving the light source to operate; a power supply module being electrically connected to the driving module for supplying power to the driving module; characterized in that: the LED lamp further comprises a connector, and an emergency module; the driving module has a first plug-in terminal which is electrically connected to the light source, the connector has a second plug-in terminal, and the emergency module has a third plug-in terminal; the connector and the emergency module are capable of being operated alternatively so that the LED lamp has the following two operation states:

in a first operation state, the second plug-in terminal of the connector is engaged with the first plug-in terminal of the driving module, the driving module and the light source are electrically connected by the connector;

in a second operation state, the third plug-in terminal of the emergency module is engaged with the first plug-in terminal of the driving module, the emergency module is electrically connected with the light source so as to drive the light source to operate.

To improve the engagement firmness, preferably, the second plug-in terminal is capable of being buckled with the first plug-in terminal, and third plug-in terminal is capable of being buckled with the first plug-in terminal.

To facilitate the disassembly or assembly of the driving module and the emergency module, preferably, the LED lamp further comprises a reflector, the driving module and the emergency module are detachably disposed on the reflector.

To enable the LED lamp realize arbitrary switching between two operation states so as to improve the assembly efficiency, preferably, the driving module has a power output anode and a power output cathode, the power supply module comprises a neutral wire, a first live wire and a second live wire; the first plug-in terminal comprises eight ports: a first port, a second port, a third port, a fourth port, a fifth port, a sixth port, a seventh port and an eighth port, the first port is connected to the anode of the light source, the second port is connected to the cathode of the light source, the third port is connected to the power output anode of the driving module, the fourth port is connected to the power output cathode of the driving module, the fifth port is connected to the neutral wire of the power supply module, the sixth port is connected to an input terminal of the driving module, the seventh port is connected to the first live wire of the power supply module, the eighth port is connected to the second live wire.

Preferably, in the first operation state, the connector is capable of connecting the first port to the third port, connecting the second port to the fourth port, and connecting the sixth port to the eighth port.

Preferably, the emergency module comprises a battery, a charging circuit, a constant voltage circuit, and an emergency conversion circuit; in the second operation state, an input terminal of the constant voltage circuit is respectively electrically connected to the fifth port and the seventh port, an output terminal of the constant voltage circuit is electrically connected to an input terminal of the charging circuit, and an output terminal of the charging circuit is electrically connected to the battery, and, the battery is electrically connected to an input terminal of the emergency conversion circuit.

To enable an electrical conduction between the emergency module and the light source, preferably, the emergency module further comprises a power supply circuit and a switch module, an input terminal of the power supply circuit is electrically connected to the battery and the output terminal of the constant voltage circuit; the switch module comprises a first relay having a first coil and a normally open contact acting with the first coil; in the second operation state, the normally open contact has two ends and the two ends of the normally open contact of the first relay are electrically connected to the sixth port and the eighth port, respectively, and the first coil is connected to an output terminal of the power supply circuit.

To enable the continuous operation of the LED lamp even after the AC power is cut off, preferably, the emergency module further comprises a booster circuit and a power supply switching circuit for switching power supplies of the first port and the second port, an output terminal of the emergency conversion circuit is electrically connected to an input terminal of the booster circuit, an output terminal of the booster circuit is electrically connected to the power supply switching circuit; in the second operation state, an output terminal of the power supply switching circuit is electrically connected to the first port, the second port, the third port and the fourth port.

To realize the switching of power supply for the light source, preferably, the power supply switching circuit comprises a second relay having a second coil and two contact groups acting with the second coil, each of the two contact groups comprises two stationary contacts and a moving contact, the two stationary contacts of one of the two contact groups are respectively connected to the third port and one output terminal of the booster circuit, and the two stationary contacts in the other contact group are respectively connected to the fourth port and the other output terminal of the booster circuit, and the moving contact in the aforementioned one contact group is connected to the second port, the second coil is connected to the output terminal of the power supply circuit.

To detect the operation state of each circuit in the emergency module, preferably, the emergency module further comprises a controller having a control terminal, and the control terminal of the controller is electrically connected to the charging circuit, the constant voltage circuit, the emergency conversion circuit, the power supply circuit and the booster circuit.

An LED lamp comprises a light source, a driving module for driving the light source to operate, and a power supply module for supplying power to the driving module, the power supply module being electrically connected to the driving module; and a connector and an emergency module. The connector and the emergency module are capable of being selectively electrically connected to the driving module so that the LED lamp has at least two operation states: when the connector is electrically connected to the driving module, an electrical connection is established between the driving module and the light source to drive the light source to operate; and when the emergency module is in plug-in electrical connection with the driving module, the emergency module supplies power to the driving module, and the electrical connection between the driving module and the light source is maintained to drive the light source to operate.

An LED lamp comprises a light source, a driving module for driving the light source to operate, and a power supply module for supplying power to the driving module, the power supply module being electrically connected to the driving module, and the driving module having a first plug-in terminal; a connector having a second plug-in terminal; and an emergency module having a third plug-in terminal. The connector and the emergency module are capable of being selectively electrically connected to the driving module so that the LED lamp has at least two operation states: when the second plug-in terminal of the connector is electrically connected to the first plug-in terminal of the driving module, an electrical connection is established between the driving module and the light source to drive the light source to operate; and when the third plug-in terminal of the emergency module is in plug-in electrical connection with the first plug-in terminal of the driving module, the emergency module supplies power to the driving module, and the electrical connection between the driving module and the light source is maintained to drive the light source to operate.

Compared with the prior art, the LED lamp of the present disclosure has the following advantages. The driving module has the first plug-in terminal, the connector has the second plug-in terminal, and the emergency module has the third plug-in terminal. The second plug-in terminal and the third plug-in terminal can be alternatively engaged with the first plug-in terminal, so that both the connector and the emergency module are capable of driving the light source to operate. Thus, the light source can be powered regardless of whether the AC power is cut off. Moreover, this LED lamp is easy to disassemble or assemble, and there is no need for manual wiring, so that the replacement efficiency of the LED lamp is improved.

### BRIEF DESCRIPTION OF DRAWINGS

FIG. 1 is an exploded view of an LED lamp in a first operation state according to an embodiment of the present disclosure;

FIG. 2 is a schematic view of a connector in FIG. 1;

FIG. 3 is a schematic view of the LED lamp in a second operation state according to the embodiment of the present disclosure;

FIG. 4 is an exploded view of FIG. 3;

FIG. 5 is a schematic view of an emergency module in FIG. 4;

FIG. 6 is a circuit diagram of a driving module according to the embodiment of the present disclosure;

FIG. 7 is a circuit diagram of the LED lamp in the first operation state according to the embodiment of the present disclosure;

FIG. 8 is a circuit diagram of a constant voltage circuit and a switch module in the emergency module according to the embodiment of the present disclosure;

FIG. 9 is a circuit diagram of a power supply circuit, a controller and a peripheral circuit in the emergency module according to the embodiment of the present disclosure;

FIG. 10 is a circuit diagram of a booster circuit and a power supply switching circuit in the emergency module according to the embodiment of the present disclosure; and

FIG. 11 is a circuit diagram of a charging circuit and an emergency conversion circuit in the emergency module according to the embodiment of the present disclosure.

FIG. 12 is a schematic view of a second embodiment of the present disclosure;

FIG. 13 is a schematic view of a first switching mechanism in FIG. 12;

FIG. 14 is a schematic view of a rotating rod, a rotating block, a mounting groove, and a first plug-in terminal in FIG. 13;

FIG. 15 is a schematic view of a driving module and a connector in FIG. 12;

FIG. 16 is a schematic view of a third embodiment of the present disclosure;

FIG. 17 is a schematic view of a second switching mechanism in FIG. 16;

FIG. 18 is a schematic view of a turned-off state in FIG. 16;

FIG. 19 is a schematic view of a fourth embodiment of the present disclosure;

FIG. 20 is a schematic view of a third switching mechanism in FIG. 19;

FIG. 21 is a schematic view of a turned-off state in FIG. 20.

### DETAILED DESCRIPTION OF THE DISCLOSURE

The technical solution in the embodiment of the present disclosure will be clearly and completely described below with reference to the drawings. Obviously, the described embodiment is part of, rather than all of the embodiments of the present disclosure. The following description of at least one exemplary embodiment is illustrative in nature and is in no way intended to limit the present disclosure, its application or uses. Based on the embodiments in the present disclosure, all other embodiments obtained by those skilled in the art without creative work belong to the scope of protection of the present disclosure.

It should be noted that the terminology used here is only for describing specific embodiments, and is not intended to limit exemplary embodiments according to the present application. As used herein, the singular form is also intended to include the plural form unless the context clearly indicates otherwise. Furthermore, it should be appreciated that when the terms "comprising" and/or "including" are used in this specification, they specify the presence of features, steps, operations, equipment, components and/or combinations thereof.

Unless otherwise specified, the relative arrangement of components and steps, numerical expressions and numerical values set forth in these embodiments do not limit the scope of the present disclosure. At the same time, it should be appreciated that for the convenience of description, the dimensions of various parts shown in the drawings are not drawn according to the actual scale relationship. Techniques, methods and equipment known to those skilled in the art may not be discussed in detail, but in appropriate cases, they should be regarded as part of the authorization specification. In all the examples shown and discussed herein, any specific values should be interpreted as illustrative, and not as limiting. Therefore, other examples of exemplary embodiments may have different values. It should be noted that similar numbers and letters indicate similar items in the following drawings, therefore once an item is defined in one drawing, it does not need to be further discussed in subsequent drawings.

The present disclosure will be further described below in detail by embodiments with reference to the accompanying drawings.

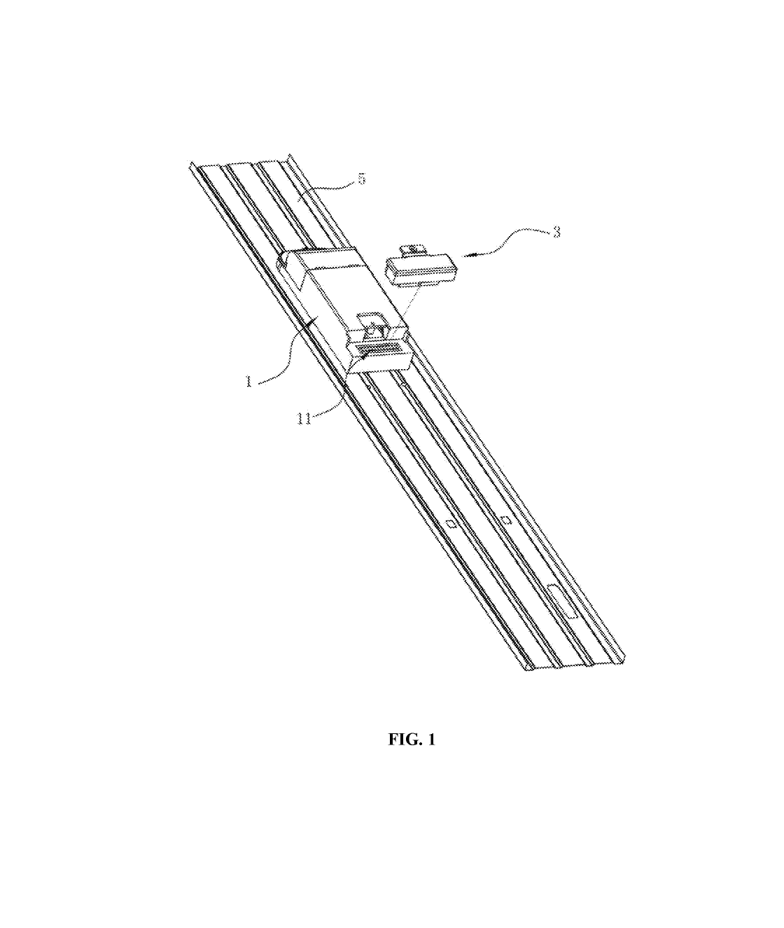

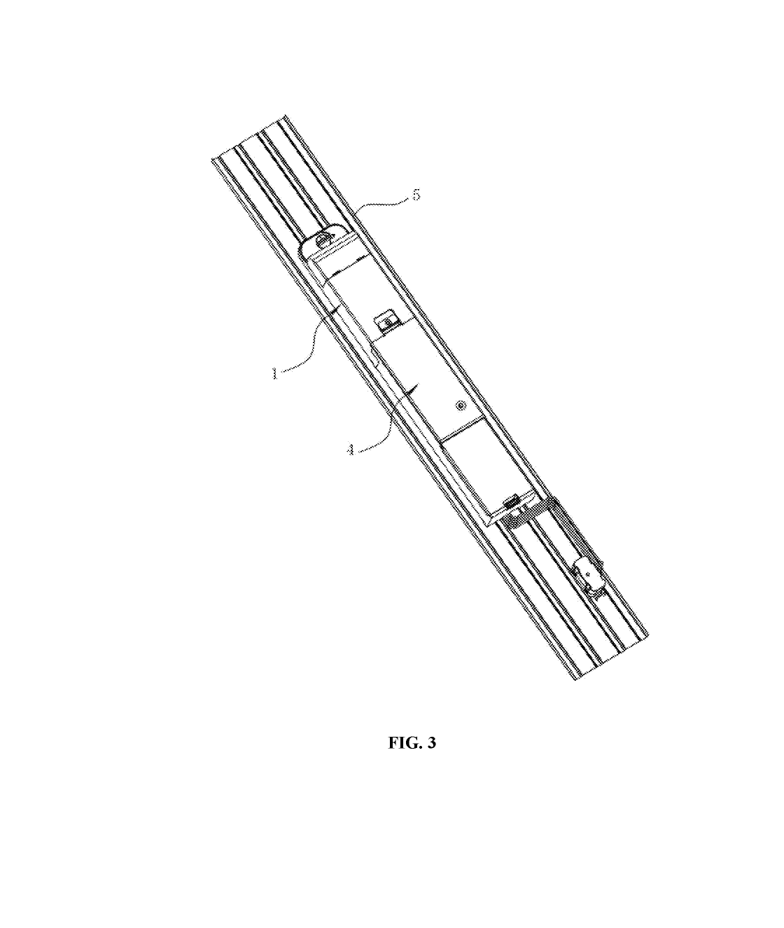

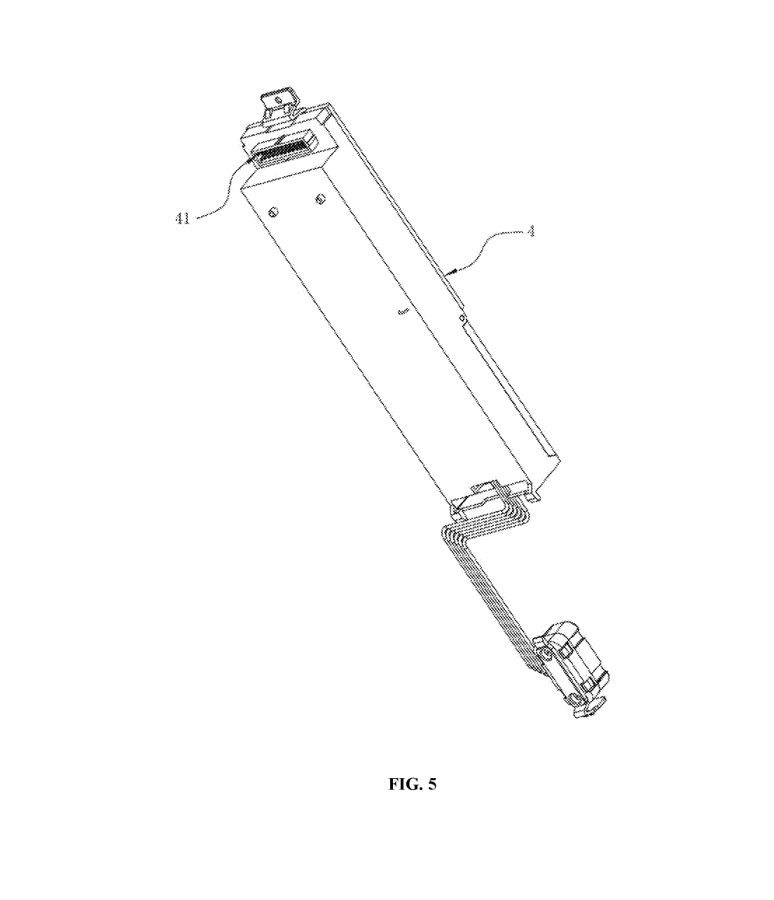

FIGS. 1-11 show a preferred embodiment of an LED lamp of the present disclosure. The LED lamp in this embodiment comprises a reflector 5, a light source having an anode and a cathode; a driving module 1 for driving the light source to operate; and a power supply module 2 being electrically connected to the driving module 1 for supplying power to the driving module 1. The power supply module 2 in this embodiment uses AC power, and the light source uses a light-emitting diode (LED). Both the driving module 1 and the emergency module 4 are detachably disposed on the reflector 5. Specifically, the driving module 1 and the emergency module 4 may be clamped with the reflector 5.

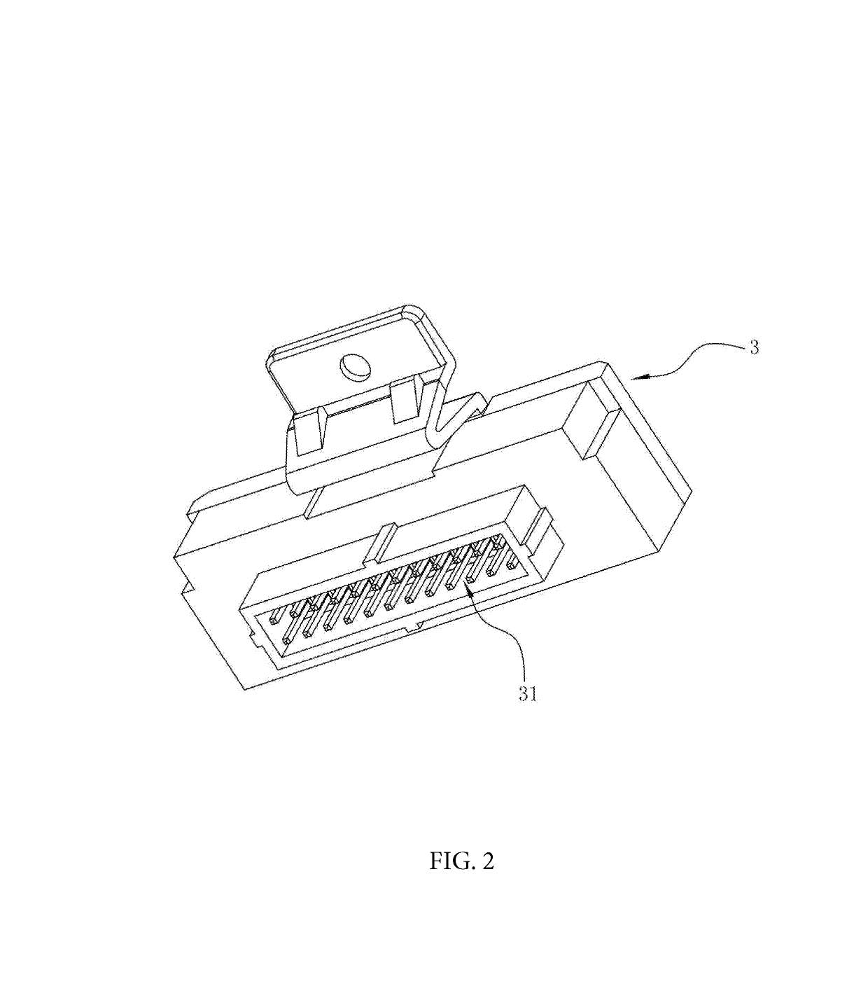

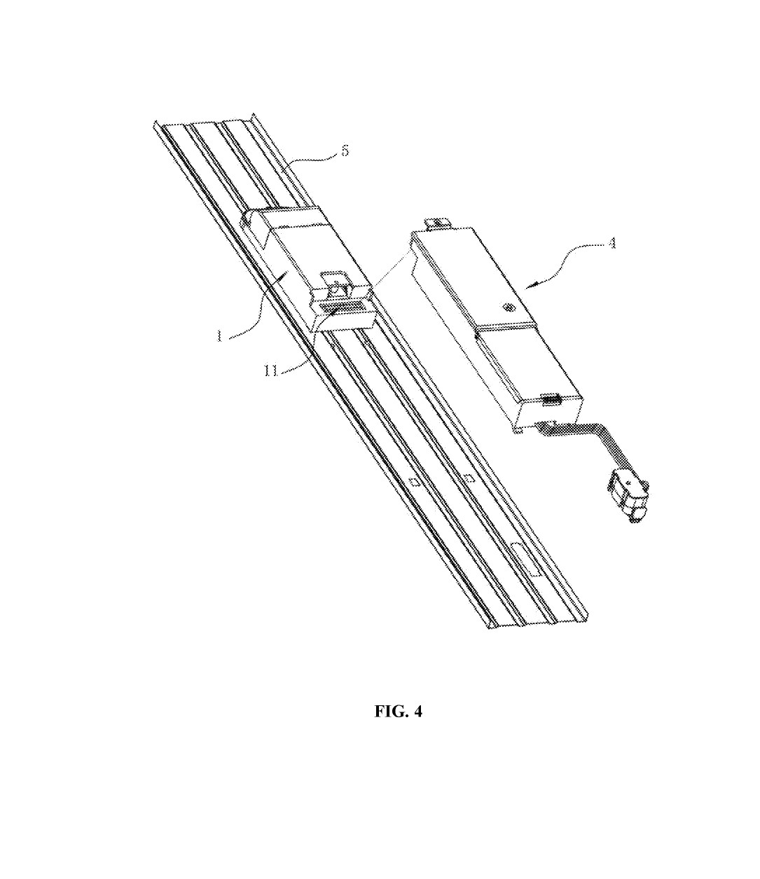

As shown in FIGS. 1-5, the LED lamp further comprises a connector 3 and an emergency module 4. The driving module 1 has a first plug-in terminal 11 which is electrically connected to the light source, the connector 3 has a second plug-in terminal 31, and the emergency module 4 has a third plug-in terminal 41. The second plug-in terminal 31 is capable of being buckled with the first plug-in terminal 11, and third plug-in terminal 41 is capable of being buckled with the first plug-in terminal 11. As shown in FIGS. 2 and 4, the detail buckled connecting structures between the second plug-in terminal 31 and first plug-in terminal 11, between third plug-in terminal 41 and the first plug-in terminal 11 belong to the prior art and will not be described here.

The connector 3 and the emergency module 4 are capable of being operated alternatively so that the LED lamp has the following two operation states: in a first operation state, the second plug-in terminal 31 of the connector 3 is engaged with the first plug-in terminal 11 of the driving module 1, the driving module 1 and the light source are electrically connected by the connector 3; in a second operation state, the third plug-in terminal 41 of the emergency module 4 is engaged with the first plug-in terminal 11 of the driving module 1, the emergency module 4 is electrically connected with the light source so as to supply power the driving module.

In this embodiment, after the connector 3 is detached from the driving module 1, an operator can engage the third plug-in terminal 41 of the emergency module 4 with the first plug-in terminal 11 of the driving module 1, thereby establishing an electrical connection between the emergency module 4 and the driving module 1. Subsequently, the connector 3 and the emergency module 4 are attached through a magnetic structure, so as to position and fix the connector 3 at the emergency module 4, thereby preventing the connector 3 from loosening, being lost, or interfering with other components, and improving assembly stability and ease of use in emergency mode.

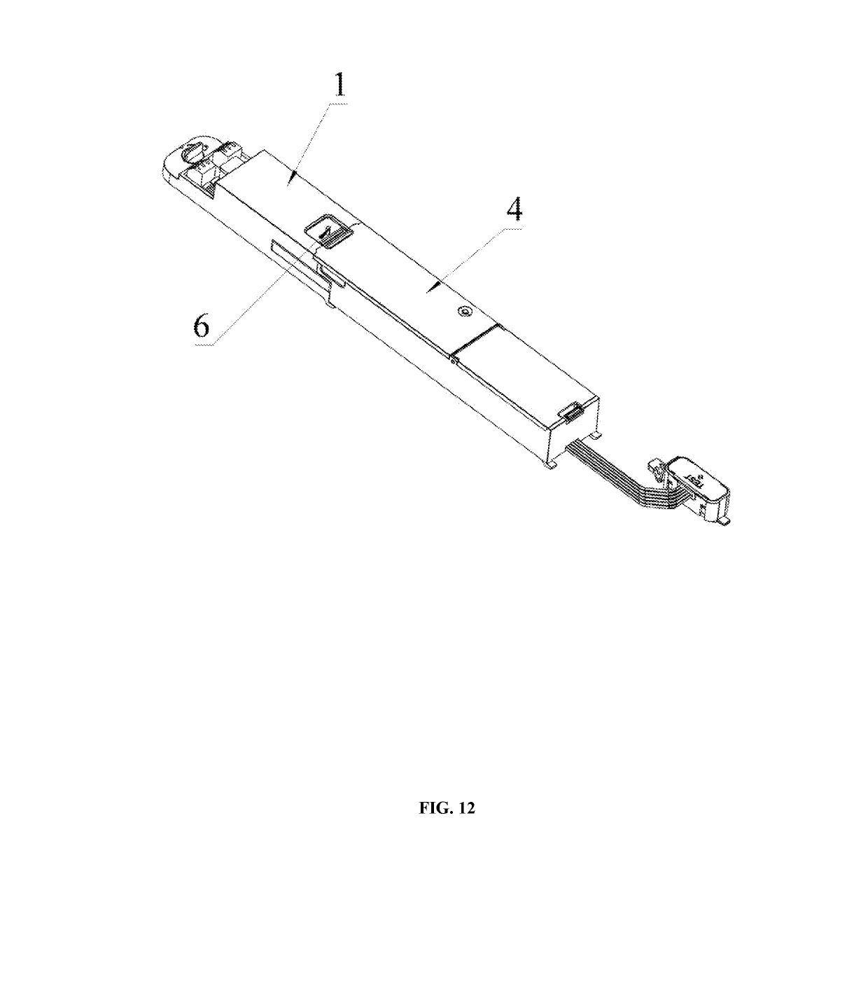

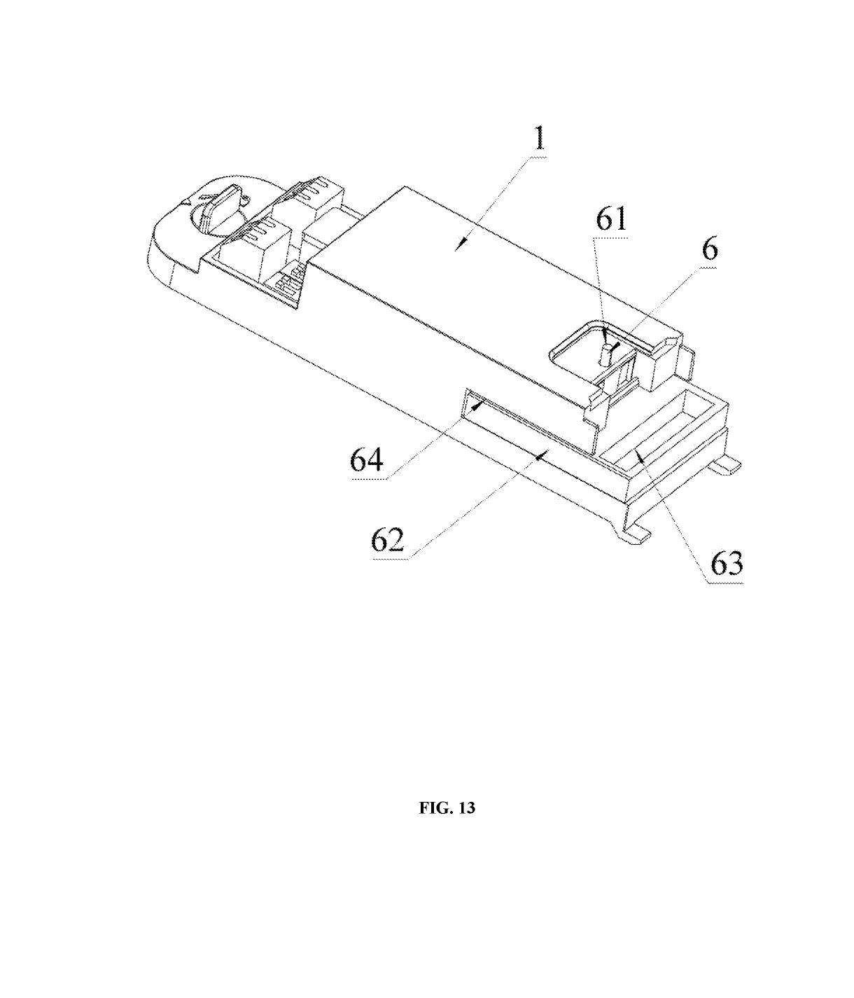

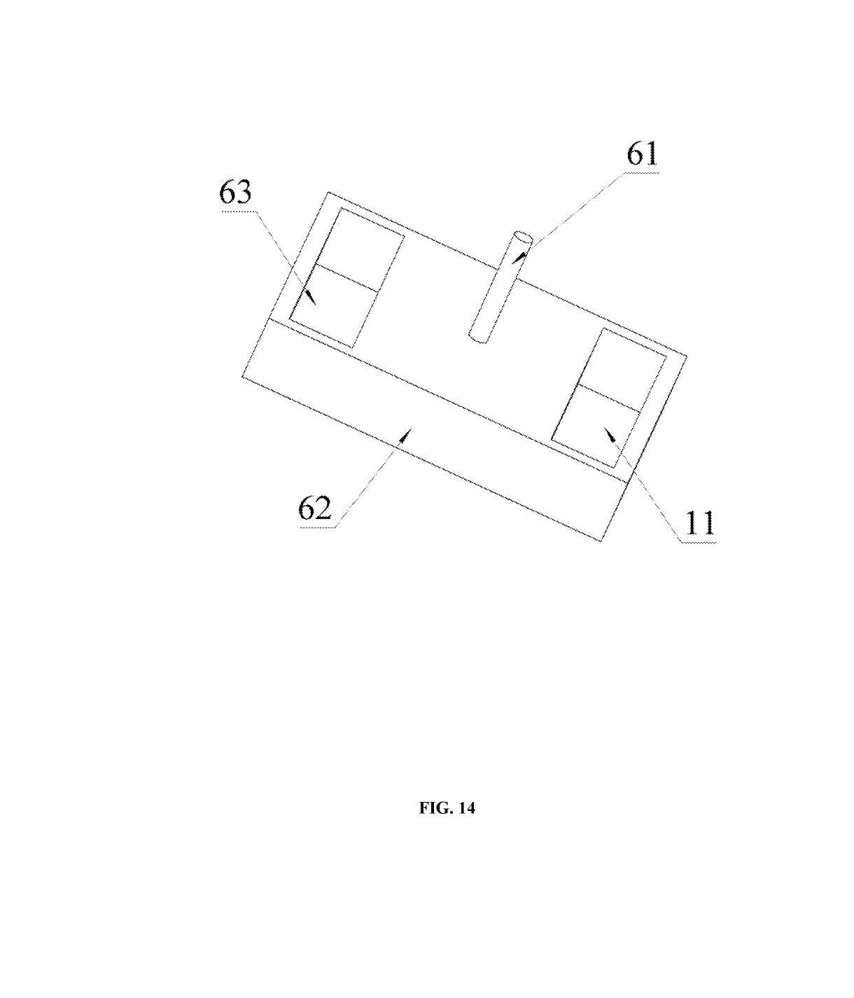

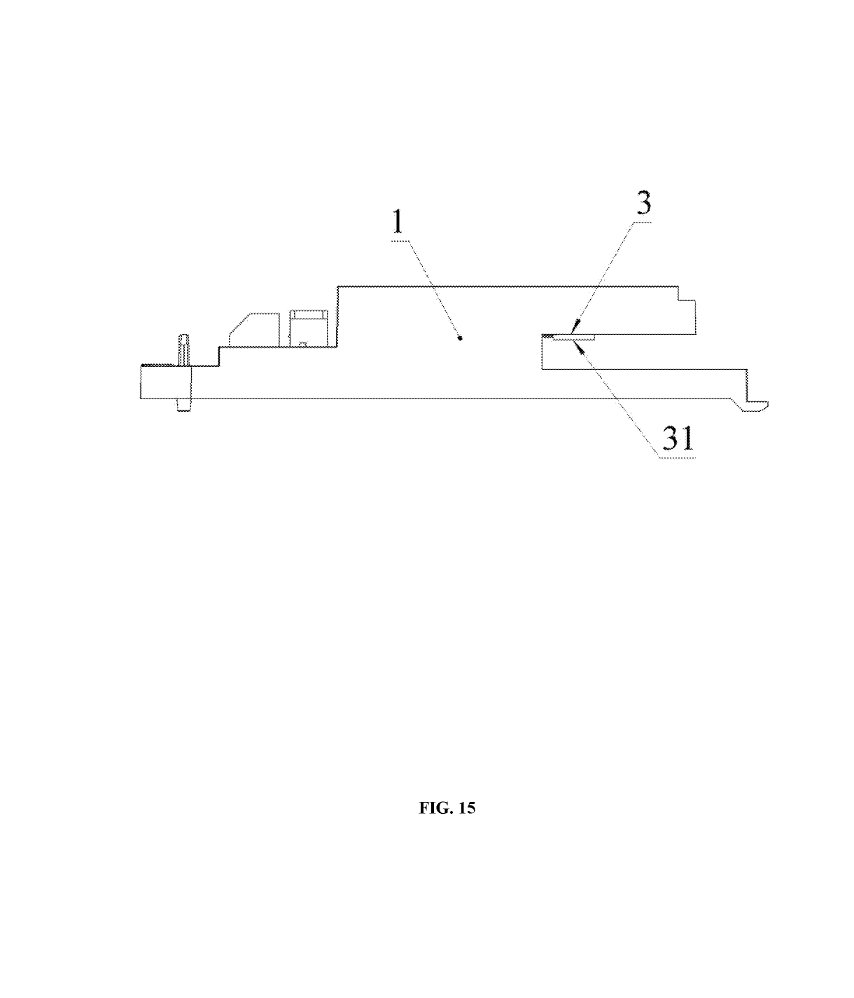

In other embodiments, as shown in FIGS. 12 to 15, this embodiment provides an LED luminaire, which includes a reflector 5, a light source, a driving module 1 for driving the light source to operate, and a power supply module 2 for supplying power to the driving module 1. The power supply module 2 is electrically connected to the driving module 1 to provide operating power to the driving module 1. In this embodiment, the power supply module 2 may adopt a mains power supply method, and the light source may use LED light-emitting diodes to achieve efficient illumination and stable lighting.

The driving module 1 and the emergency module 4 are both detachably mounted on the reflector 5. Specifically, the driving module 1 and the emergency module 4 can each be quickly assembled and disassembled with the reflector 5 through a snap-fit structure, facilitating maintenance, replacement, or switching between different power supply modes. The emergency module 4 is provided with a third plug-in terminal 41 for being engaged with the driving module 1 to form an electrical connection.

Here, the driving module 1 is equipped with a first switching mechanism 6, used to selectively connect the connector 3 and the emergency module 4 as needed, thereby establishing the corresponding power supply path. The first switching mechanism 6 includes a rotating rod 61 rotatably arranged inside the driving module 1; the rotating rod 61 can rotate smoothly through bearing support. A rotating groove 64 is formed inside the driving module 1, and the bottom of the rotating rod 61 is connected to a rotating block 62 located within the rotating groove 64. The top ends of the rotating block 62 respectively form a first plug-in terminal 11 and a mounting groove 63. Here, the first plug-in terminal 11 is electrically connected to the power supply module 2, used to provide an external pluggable power supply interface; the mounting groove 63 is used to accommodate, avoid, or limit related structures during the rotational switching process, preventing interference and improving switching reliability. A connector 3 is arranged at the inner top wall of the driving module 1, located within the rotating groove 64; the bottom of the connector 3 is provided with a second plug-in terminal 31. The connector 3 is used to conduct electricity between the driving module 1 and the light source, thereby establishing the electrical connection path from the driving module 1 to the light source under normal power supply conditions.

When it is necessary to place the connector 3 and the driving module 1 in an electrical connection state, the first plug-in terminal 11 on the rotating block 62 is located inside the rotating groove 64, and the second plug-in terminal 31 at the bottom of the connector 3 is fitted or engaged with the first plug-in terminal 11, thereby conducting electricity between the driving module 1 and the light source through the connector 3, achieving power supply and illumination in the normal operating mode.

When it is necessary to establish an electrical connection between the driving module 1 and the emergency module 4 to enter emergency power supply mode, the operator rotates the rotating rod 61. The rotating rod 61 drives the rotating block 62 to rotate relative to the rotating groove 64, causing the first plug-in terminal 11 to switch its position relative to the rotating groove 64. Specifically, when the rotating block 62 rotates to a predetermined angle, the first plug-in terminal 11 rotates from inside the rotating groove 64 to the outside of the rotating groove 64 and becomes pluggable. Simultaneously, the mounting groove 63 correspondingly rotates into the interior of the rotating groove 64 to provide clearance, thereby creating space for emergency plugging and avoiding interference with the connector 3. At this point, by inserting the third plug-in terminal 41 of the emergency module 4 into the first plug-in terminal 11, the emergency module 4 can supply power to the driving module 1, enabling the driving module 1 to continue driving the light source to operate, thus completing the emergency power connection.

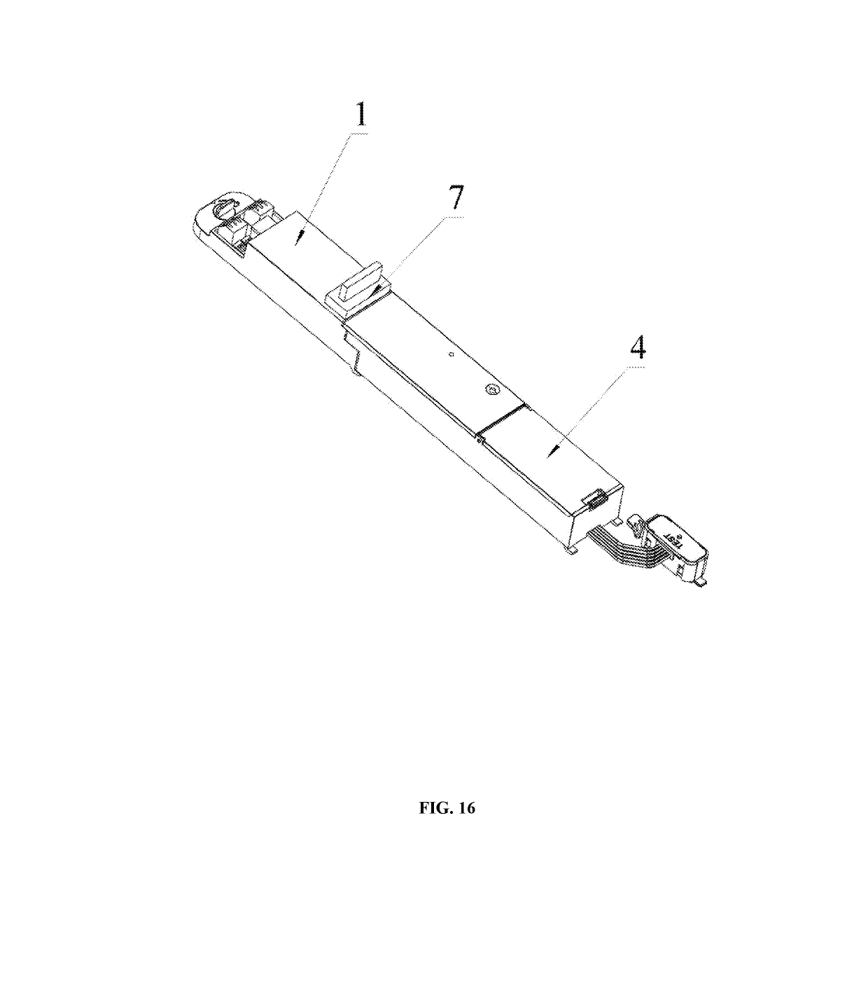

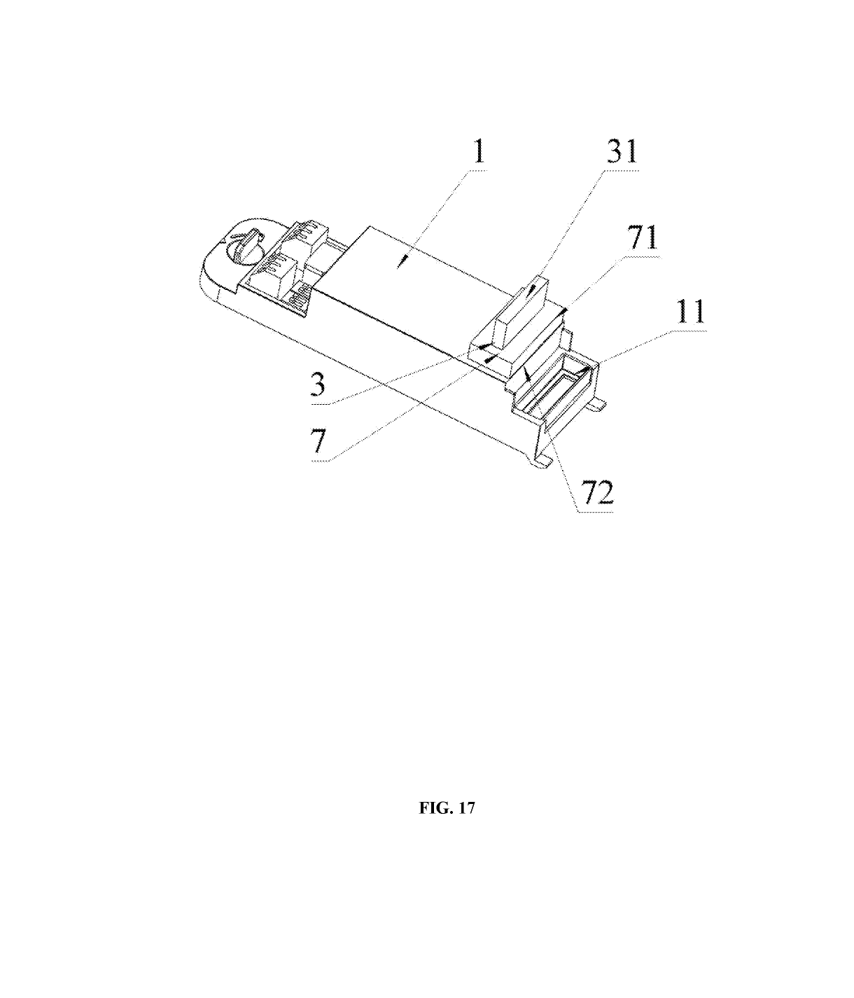

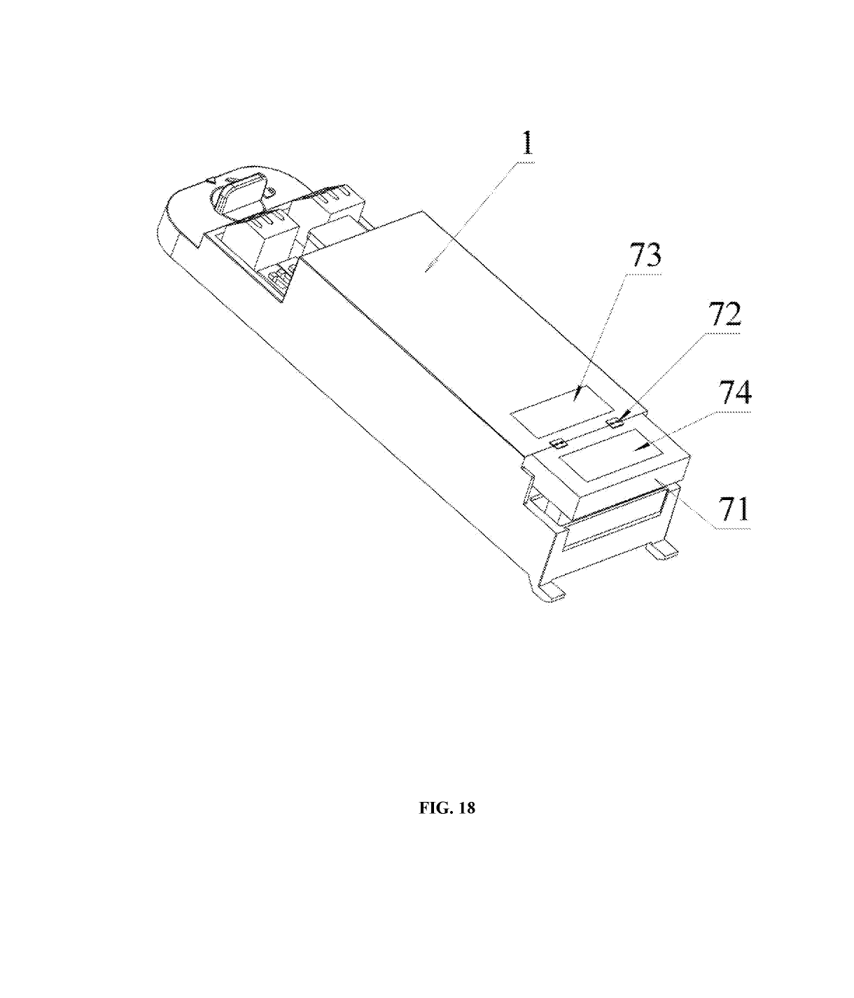

In other embodiments, as shown in FIGS. 16 to 18, this embodiment provides an LED luminaire, which includes a reflector 5, a light source, a driving module 1 for driving the light source to operate, and a power supply module 2 for supplying power to the driving module 1. The power supply module 2 is electrically connected to the driving module 1 to provide operating electrical energy. In this embodiment, the power supply module 2 can adopt mains power supply, and the light source can use LED light-emitting diodes to achieve stable illumination and high energy efficiency.

Both the driving module 1 and the emergency module 4 are detachably mounted on the reflector 5. Specifically, the driving module 1 and the emergency module 4 can be detachably connected to the reflector 5 through a snap-fit structure, facilitating assembly, inspection, replacement, or switching between different power supply modes. The driving module 1 is provided with a first plug-in terminal 11, and the emergency module 4 is provided with a third plug-in terminal 41, which are used for engagement and forming an electrical connection during emergency power supply.

Here, the driving module 1 is provided with a second switching mechanism 7. The second switching mechanism 7 is used to shield and protect the first plug-in terminal 11 and to achieve selective access between the connector 3 and the emergency module 4. The second switching mechanism 7 includes a first protective cover 71 and a first hinge 72. The first protective cover 71 is hinged to the driving module 1 through the first hinge 72, allowing it to rotate and switch relative to the driving module 1 between a closed position and an open position. The connector 3 is arranged on the first protective cover 71, and the second plug-in terminal 31 is set on the connector 3, enabling the connector 3 to move synchronously with the rotation of the first protective cover 71, thereby achieving engagement or disengagement with the first plug-in terminal 11 at different positions.

To enhance stability after flipping into place, a first magnet 73 is provided on the driving module 1, and a second magnet 74 is provided on the first protective cover 71. The two can attract each other when the first protective cover 71 rotates to a predetermined open position, thereby positioning and retaining the first protective cover 71, improving stability in the turned-on state, preventing the first protective cover 71 from rebounding or accidentally closing and affecting plug-in operations, and facilitating the operator to complete plugging and switching with one hand.

It should be appreciated that, under normal power supply conditions, the second plug-in terminal 31 on the connector 3 is engaged with the first plug-in terminal 11 on the driving module 1, enabling conduction between the driving module 1 and the light source to ensure normal operation of the light source.

When it is necessary for the emergency module 4 to supply power to the driving module 1, the operator rotates the first protective cover 71 in the opening direction. Under the action of the first hinge 72, the first protective cover 71 drives the connector 3 to rotate relative to the first plug-in terminal 11, causing the second plug-in terminal 31 to disengage from the first plug-in terminal 11 and exposing the first plug-in terminal 11 in a pluggable state. Subsequently, the second magnet 74 on the first protective cover 71 and the first magnet 73 on the driving module 1 attract each other, stably holding the first protective cover 71 in the open position and preventing the connector 3 from returning and interfering with plugging. At this point, inserting the third plug-in terminal 41 of the emergency module 4 into the first plug-in terminal 11 establishes an electrical connection between the emergency module 4 and the driving module 1, thereby supplying power to the driving module 1, which continues to drive the light source to operate, completing the access of emergency power supply.

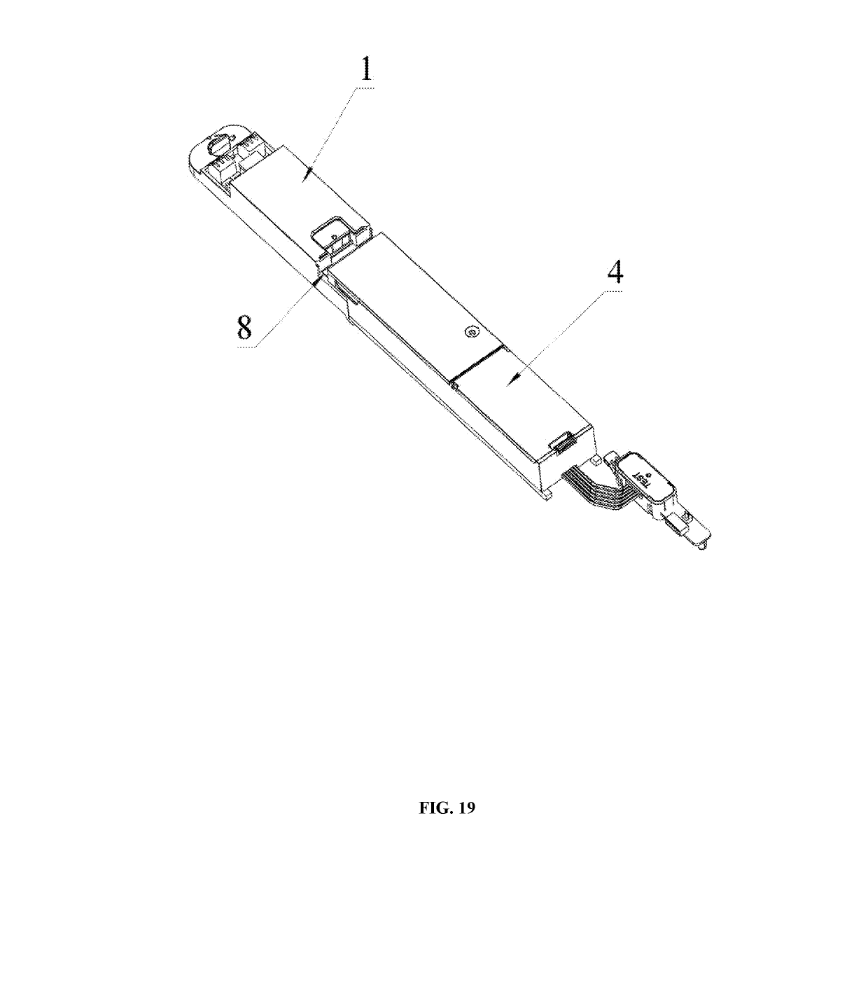

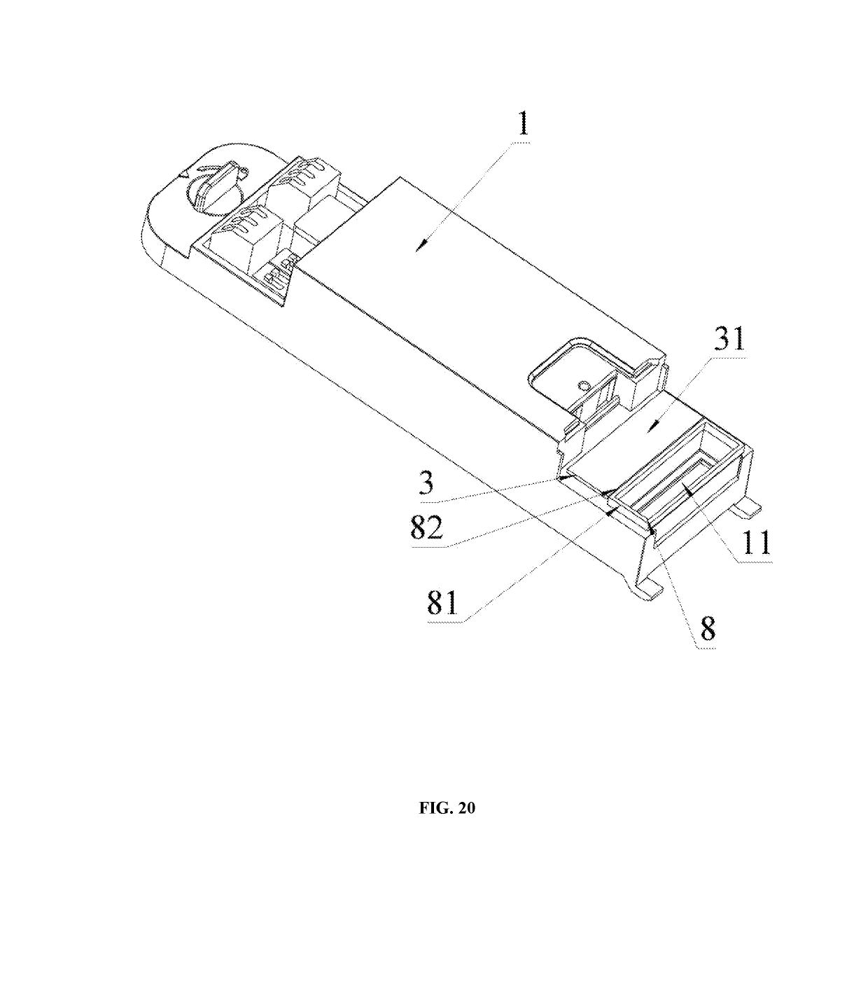

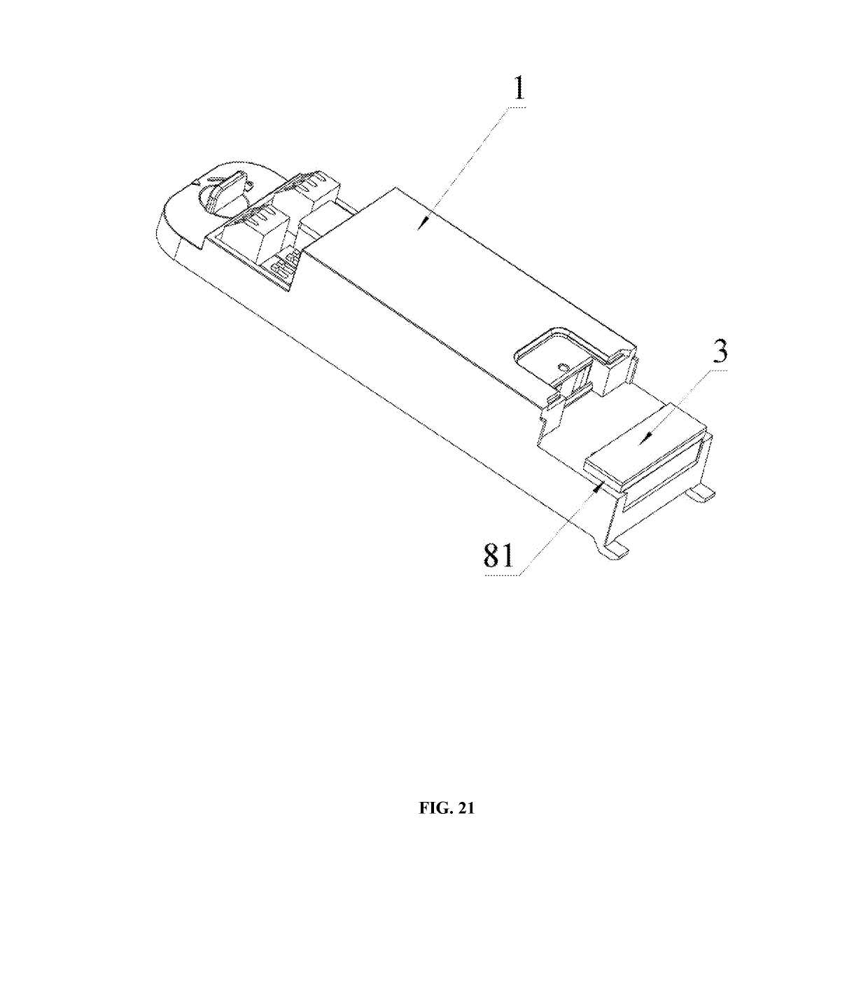

In other embodiments, as shown in FIGS. 19 to 21, this embodiment provides an LED luminaire, which includes a reflector 5, a light source, a driving module 1 for driving the light source, and a power supply module 2 for supplying power to the driving module 1. The power supply module 2 is electrically connected to the driving module 1 to provide operating power. In this embodiment, the power supply module 2 can adopt mains power supply, and the light source can use LED light-emitting diodes to achieve stable illumination and high luminous efficiency.

Both the driving module 1 and the emergency module 4 are detachably mounted on the reflector 5. Specifically, the driving module 1 and the emergency module 4 can be detachably connected to the reflector 5 through a snap-fit structure, facilitating assembly, maintenance, replacement, or switching between different power supply modes. The driving module 1 is provided with a first plug-in terminal 11, and the emergency module 4 is provided with a third plug-in terminal 41, which are used for engagement and forming an electrical connection under emergency power supply conditions.

Here, a third switching mechanism 8 is provided on the driving module 1. The third switching mechanism 8 is used to protect the first plug-in terminal 11 and to achieve selective switching between the conventional power supply state and the emergency power supply access state. The third switching mechanism 8 includes a protective frame 81 and a second hinge 82. The protective frame 81 has a rectangular frame structure, is installed on the driving module 1 and surrounds the periphery of the first plug-in terminal 11, and is arranged corresponding to the position of the first plug-in terminal 11, thereby forming shielding and limiting protection around the terminal, reducing the risk of accidental contact, foreign object intrusion, or collision damage, while also serving a guiding and positioning function to facilitate subsequent plugging operations.

The connector 3 is hinged to the protective frame 81 through the second hinge 82, allowing the connector 3 to rotate and switch relative to the protective frame 81 between a turned-off state and a turned-on state. The connector 3 can form a flip cover structure, on which a second plug-in terminal 31 is provided. It should be appreciated that when the connector 3 is in the turned-off state and fits against the protective frame 81, the second plug-in terminal 31 contacts or is engaged with the first plug-in terminal 11 to form an electrical connection, thereby conducting electricity between the driving module 1 and the light source through the connector 3, achieving power supply and lighting in the conventional working mode; simultaneously, the connector 3 covers the outside of the first plug-in terminal 11, providing shielding protection for the first plug-in terminal 11.

When it is necessary to install the emergency module 4 and access emergency power supply, the operator rotates the connector 3 along the opening direction, causing it to flip around the second hinge 82 to a predetermined open position, thereby moving the connector 3 away from the first plug-in terminal 11 and exposing the first plug-in terminal 11, placing it in a pluggable state. Subsequently, the third plug-in terminal 41 of the emergency module 4 is inserted into the first plug-in terminal 11, establishing an electrical connection between the emergency module 4 and the driving module 1, thereby allowing the emergency module 4 to supply power to the driving module 1, which continues to drive the light source to operate, completing the access of emergency power supply.

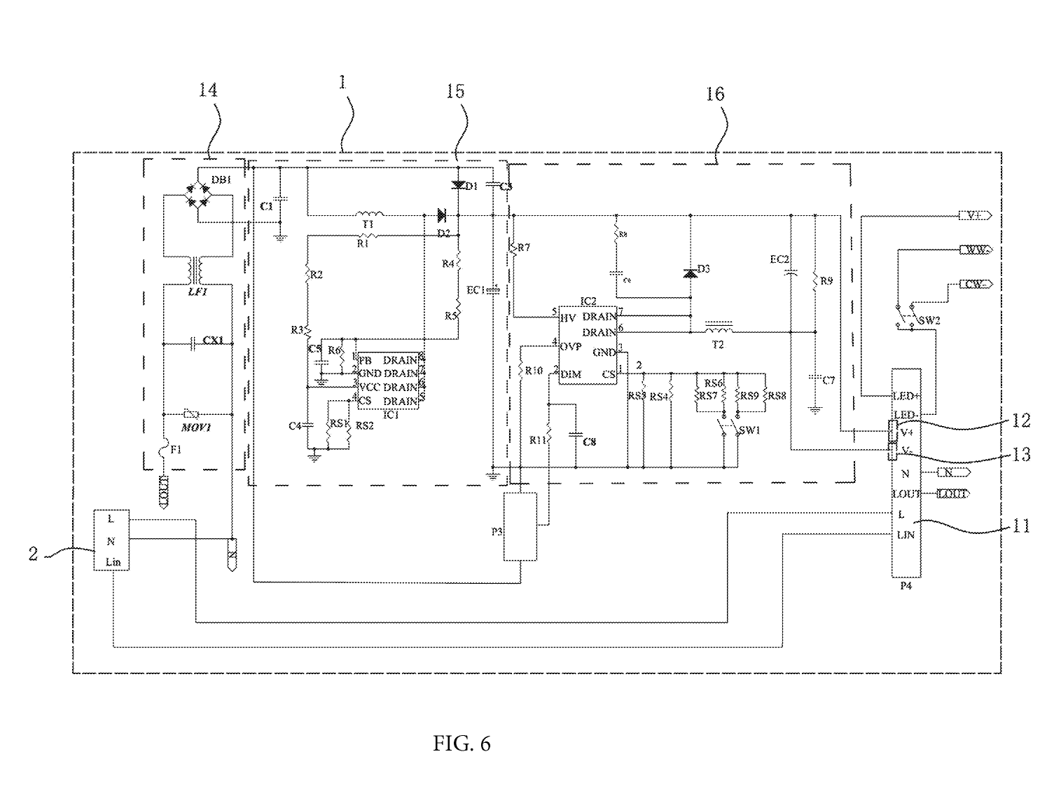

As shown in FIG. 6, in this embodiment, the driving module 1 has a power output anode 12 and a power output cathode 13, the power supply module 2 comprises a neutral wire N, a first live wire L and a second live wire Lin; the first plug-in terminal 11 comprises eight ports: a first port LED+, a second port LED-, a third port V+, a fourth port V-, a fifth port N, a sixth port LOUT, a seventh port L and an eighth port LIN, the first port LED+ is connected to the anode of the light source, the second port LED- is connected to the cathode of the light source, the third port V+ is connected to the power output anode 12 of the driving module 1, the fourth port V- is connected to the power output cathode 13 of the driving module 1, the fifth port N is connected to the neutral wire N of the power supply module 2, the sixth port LOUT is connected to an input terminal of the driving module 1, the seventh port L is connected to the first live wire L of the power supply module 2, the eighth port LIN is connected to the second live wire Lin. The light source is not shown in FIG. 6, the port V+ connected to the first port LED+ in FIG. 6 corresponds to the anode of the light source, and the second port LED- is connected with ports WW- and CW- through a shift switch SW2, where both the ports WW- and CW- correspond to the cathode of the light source. The shift switch SW2 is capable of adjusting the color temperature of the light source. The driving module 1 in FIG. 6 comprises a filter circuit 14, a power factor correction (PFC) circuit 15 and an AC-DC conversion circuit 16 which are electrically connected one by one.

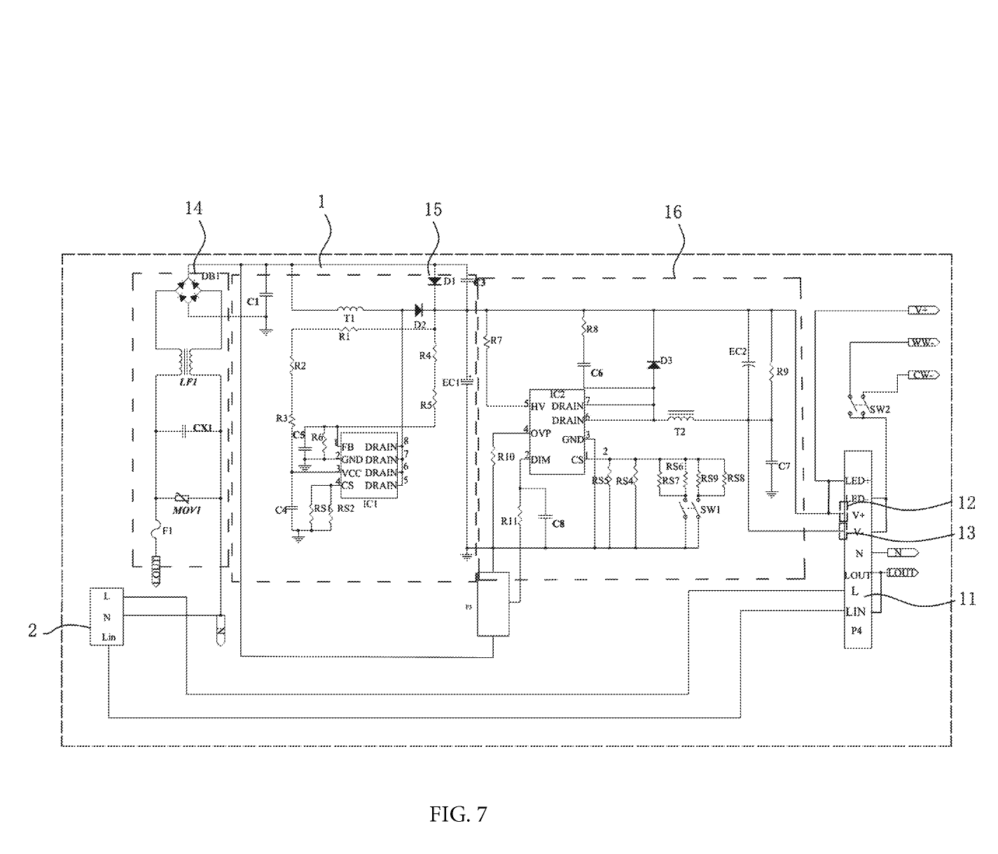

As shown in FIG. 7, in the first operation state, the connector 3 is capable of connecting the first port LED+ to the third port V+, connecting the second port LED- to the fourth port V-, and connecting the sixth port LOUT to the eighth port LIN. Thus, the driving module 1 can be powered by the power supply module 2 (which uses AC power). The power output anode 12 of the driving module 1 is connected to the anode of the light source, and the power output cathode 13 is connected to the cathode of the light source, so that the light source is driven to operate.

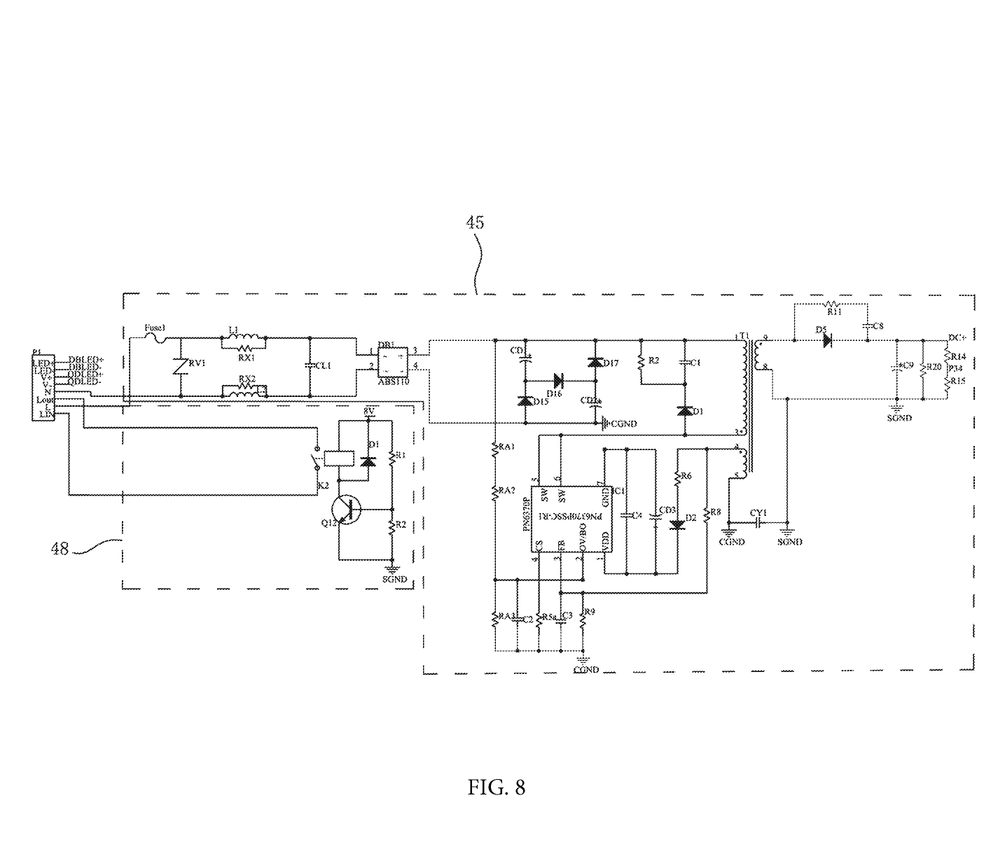

As shown in FIGS. 8-11, the emergency module 4 comprises a battery BATT, a charging circuit 44, a constant voltage circuit 45, and an emergency conversion circuit 46, a power supply circuit 47 and a switch module 48, a booster circuit 49, a power supply switching circuit 40 and a controller 4a.

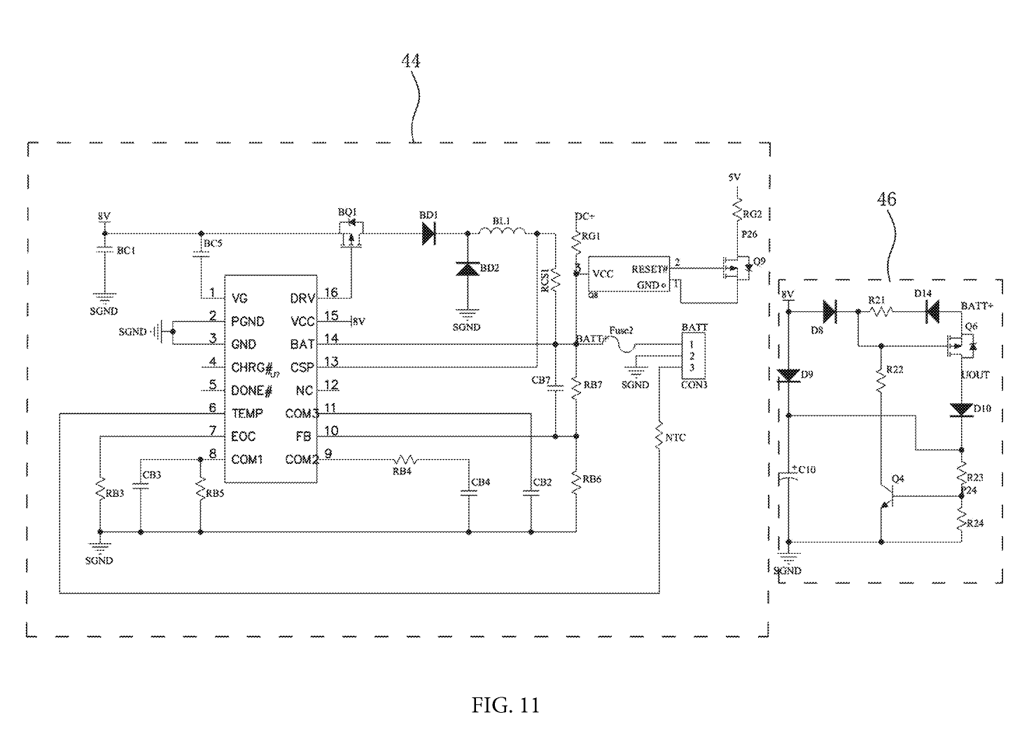

The constant voltage circuit 45 and the switch module 48 are shown in FIG. 8, and the charging circuit 44 and the emergency conversion circuit 46 are shown in FIG. 11. In the second operation state, an input terminal of the constant voltage circuit 45 is respectively electrically connected to the fifth port N and the seventh port L, an output terminal (which corresponds to DC+ in FIG. 8) of the constant voltage circuit 45 is electrically connected to an input terminal of the charging circuit 44, and an output terminal of the charging circuit 44 is electrically connected to the battery BATT, and, an output terminal (which corresponds to BATT+ in FIG. 11) of the battery BATT is electrically connected to an input terminal of the emergency conversion circuit 46. The output terminal of the emergency conversion circuit 46 corresponds to UOUT in FIG. 11.

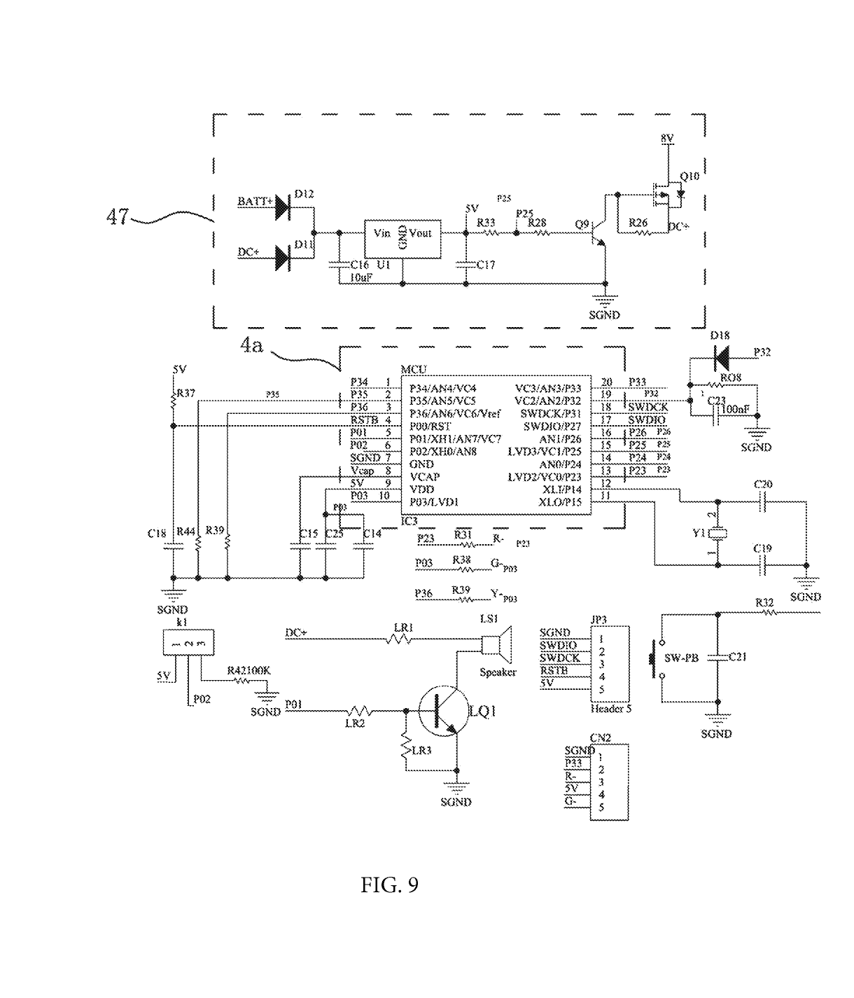

The power supply circuit 47 is shown in FIG. 9. An input terminal of the power supply circuit 47 is electrically connected to the battery BATT and the output terminal of the constant voltage circuit 45. The output terminal of the power supply circuit 47 corresponds to 8V in FIG. 9 (the power supply voltage 17 with other numerical value may also be output by the power supply circuit 17 in this embodiment). The switch module 48 comprises a first relay K2 having a first coil and a normally open contact acting with the first coil. In the second operation state, the normally open contact has two ends and the two ends of the normally open contact of the first relay K2 are electrically connected to the sixth port LOUT and the eighth port LIN, respectively, and the first coil is connected to an output terminal of the power supply circuit 47. Thus, in the second operation state, an electrical conduction is realized between the sixth port LOUT and the eighth port LINK.

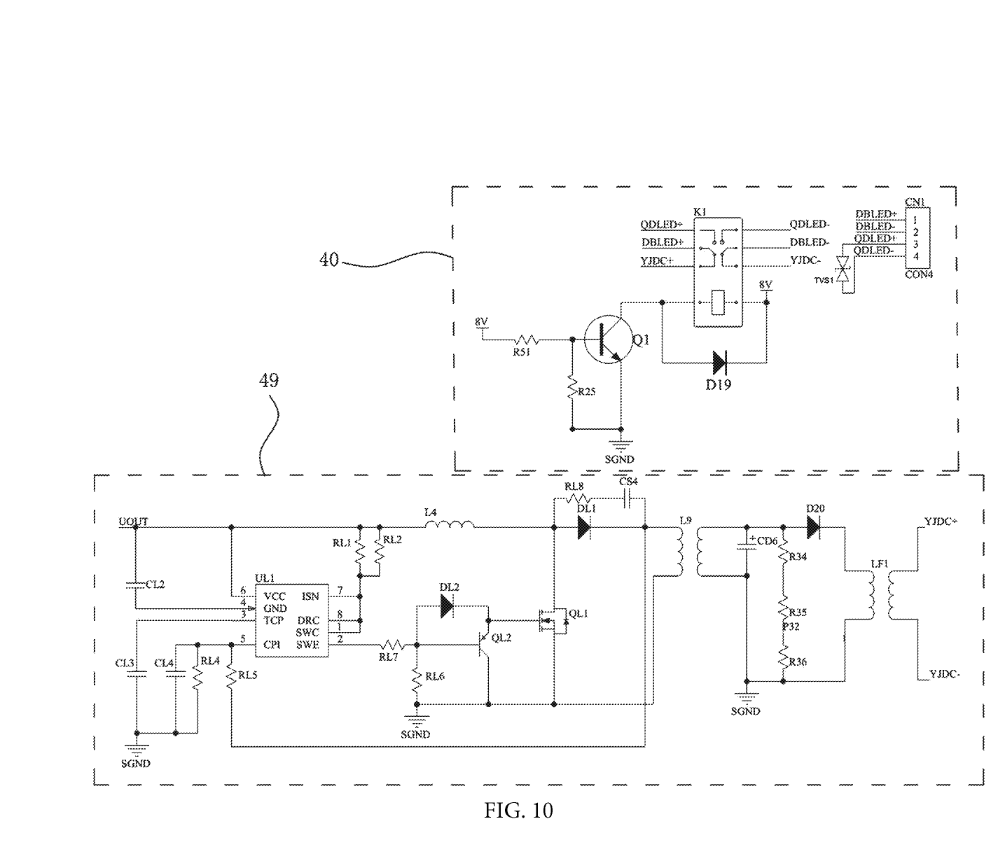

An output terminal of the emergency conversion circuit 46 is electrically connected to an input terminal of the booster circuit 49. The booster circuit 49 is shown in FIG. 10. An output terminal (which corresponds to YJDC+ and YJDC- shown in FIG. 10) of the booster circuit 49 are electrically connected to the power supply switching circuit 40. In this embodiment, the emergency conversion circuit 46 comprises a first switch device (which corresponds to a triode Q4), a second switch device (which corresponds to an MOS transistor Q6, an electrolytic capacitor (C10), and resistors (R21, R22, R23 and R24)). By adjusting the voltage of the voltage division point through the charging and discharging characteristics of the electrolytic capacitor and in combination with the resistors R21, R22, R23 and R24, the on/off of the triode Q4 and the on/off of the MOS transistor Q6 can be controlled, so that the on/off voltage of the battery can be accurately set without MCU control.

In the second operation state, an output terminal of the power supply switching circuit 40 is electrically connected to the first port LED+, the second port LED-, the third port V+ and the fourth port V-. The power supply switching circuit 40 switches power supplies of the first port LED+ and the second port LED-. As shown in FIG. 10, in this embodiment, the power supply switching circuit 40 comprises a second relay K2 having a second coil and two contact groups acting with the second coil, each of the two contact groups comprises two stationary contacts and a moving contact, the two stationary contacts of one of the two contact groups are respectively connected to the third port V+ and one output terminal of the booster circuit 49, and the two stationary contacts in the other contact group are respectively connected to the fourth port V- and the other output terminal of the booster circuit 49, and the moving contact in the aforementioned one contact group is connected to the second port LED-, the second coil is connected to the output terminal of the power supply circuit 47. Thus, when the LED lamp is in the second operation state, the power supply circuit 47 can supply power to the second coil. After the second coil is energized, since there is voltage at the output terminal of the booster voltage 49, the moving contacts of the two contact groups are switched to be connected to the first port LED+ and the second port LED-, so that the emergency module 4 supplies power to the light source, thereby driving the light source to operate.

In this embodiment, the controller 4a uses an MCU, and a control port of the controller 4a is electrically connected to the charging circuit 44, the constant voltage circuit 45, the emergency conversion circuit 46, the power supply circuit 47 and the booster circuit 49. In this embodiment, the 15th port (which corresponds to P25) of the MCU is disposed for emergency state switching, the 1st port (which corresponds to P34) of the MCU is disposed for voltage state detection, and the 19th port (which corresponds to P32) of the MCU is disposed for the detection of a lamp panel. When the lamp panel is inserted between the resistors R35 and R36 of the booster voltage 49, the detection voltage at the 19th port of the MCU is less than 1 V; and, when no lamp panel is inserted between the resistors R35 and R36 of the booster voltage 49, the detection voltage at the 19th port of the MCU is greater than 1.5 V. The 14th port (which corresponds to P24) of the MCU is disposed for starting the test for the first time, and the 16th port (which corresponds to P26) of the MCU is used for the in-situ test of the battery. Of course, the port of the MCU is also connected to a state indication module, which will not be described here.

In this embodiment, the connector 3 can be chosen to be engaged with the driving module 1, at this time, the driving module 1 is powered by the AC power, accordingly the driving module 1 drives the light source to operate. Of course, the emergency module 4 also can be chosen to be engaged with the driving module 1, the emergency module 4 can be used when power is supplied by the AC power, and the battery is charged by the AC power, so that the emergency module 4 drives the light source to operate. In addition, the emergency module 4 can also be switched to supply power to the light source through the battery even after the AC power is cut off.

In the description of the present disclosure, it should be appreciated that directional terms such as "front, rear, up, down, left, right", "horizontal, vertical, perpendicular, horizontal" and "top, bottom" etc. indicate the orientation or positional relationship based on the orientation or positional relationship shown in the drawings, and are only for the convenience of describing the present disclosure and simplifying the description. In the absence of a contrary explanation, these directional terms do not indicate or imply that the device or element referred to must have a specific orientation or be constructed and operated in a specific orientation, and therefore should not be understood as limiting the scope of protection of the present disclosure; the directional terms "inside, outside" refer to the inside and outside relative to the contour of each component itself.

For the convenience of description, spatial relative terms such as "on...", "above...", "on the upper surface of...", "upper" etc. may be used here to describe the spatial positional relationship of a device or feature with other devices or features as shown in the drawings. It should be appreciated that spatial relative terms are intended to encompass different orientations of the device in use or operation other than the orientation described in the drawings. For example, if the device in the drawing is inverted, the device described as "above other devices or structures" or "on other devices or structures" will subsequently be positioned as "below other devices or structures" or "under other devices or structures". Thus, the exemplary term "above" can include both "above" and "below" orientations. The device can also be positioned in other different ways (rotated 90 degrees or in other orientations), and the spatial relative descriptions used here should be interpreted accordingly.

In addition, it should be noted that the use of terms such as "first", "second" etc. to define components is for the convenience of distinguishing the corresponding components. Unless otherwise stated, the above terms have no special meaning, and therefore should not be understood as limiting the scope of protection of the present disclosure.

The above description is only a preferred embodiment of the present disclosure and is not intended to limit the present disclosure. For those skilled in the art, the present disclosure can have various modifications and changes. Any modifications, equivalent replacements, improvements etc. made within the spirit and principles of the present disclosure should be included within the scope of protection of the present disclosure.

What is claimed is:

1. An LED lamp, comprising:
a light source, a driving module for driving the light source to operate, and a power supply module for supplying power to the driving module, the power supply module being electrically connected to the driving module; and
a connector and an emergency module;
wherein the connector and the emergency module are capable of being selectively electrically connected to the driving module so that the LED lamp has at least two operation states:
when the connector is electrically connected to the driving module, an electrical connection is established between the driving module and the light source to drive the light source to operate; and
when the emergency module is in plug-in electrical connection with the driving module, the emergency module supplies power to the driving module, and the electrical connection between the driving module and the light source is maintained to drive the light source to operate.

2. The LED lamp according to claim 1, further comprising a reflector, and the driving module and the emergency module are detachably mounted on the reflector.

3. The LED lamp according to claim 2, wherein the driving module and the emergency module are detachably connected to the reflector through a snap-fit structure.

4. The LED lamp according to claim 1, wherein the driving module has a first plug-in terminal, the connector has a second plug-in terminal, and the emergency module has a third plug-in terminal;
when the first plug-in terminal is engaged with the second plug-in terminal and the first plug-in terminal is engaged with the third plug-in terminal, a locked connection is achieved through a buckling structure; and
a switching mechanism is provided on the driving module for switching between an electrical connection state of the connector and the driving module, and an electrical connection state of the emergency module and the driving module.

5. The LED lamp according to claim 4, wherein when the emergency module is electrically connected to the driving module, the connector and the emergency module are engaged by adsorption through a magnetic structure, so as to position and secure the connector at the emergency module.

6. The LED lamp according to claim 4, wherein the switching mechanism comprises a first switching mechanism, the first switching mechanism comprising a rotating rod rotatably arranged in the driving module and a rotating block connected to the rotating rod; and
the rotating block is provided with the first plug-in terminal, and by rotating the rotating rod, the first plug-in terminal is switched between different positions to respectively achieve the electrical connection of the connector and the driving module, and the plug-in electrical connection of the emergency module and the driving module.

7. The LED lamp according to claim 6, wherein a rotating groove is formed in the driving module, a rotating block is located in the rotating groove, and the connector is located on the driving module;
different positions comprise a first position and a second position; when the first plug-in terminal is in the first position, the first plug-in terminal is located in the rotating groove andis fitted with the second plug-in terminal; and
when the first plug-in terminal is in the second position, the the first plug-in terminal is switched from inside the rotating groove to outside the rotating groove and is in a state capable of being plugged with the third plug-in terminal.

8. The LED lamp according to claim 7, wherein a mounting groove is further formed on the rotating block, and when the first plug-in terminal is switched to the second position, the mounting groove rotates into the rotating groove to achieve avoidance.

9. The LED lamp according to claim 4, wherein the switching mechanism comprises a second switching mechanism, the second switching mechanism comprising a first protective cover and a first hinge, the first protective cover being hinged to the driving module through the first hinge; and
the connector is arranged on the first protective cover, and the second plug-in terminal rotates and switches with the first protective cover between a closed position and an open position, to switch between a state where the second plug-in terminal is engaged with the first plug-in terminal, and a state where the first plug-in terminal is exposed to be pluggable with the third plug-in terminal.

10. The LED lamp according to claim 9, wherein a first magnet is arranged on the driving module, and a second magnet is arranged on the first protective cover; when the first protective cover rotates to a predetermined open position, the first magnet and the second magnet attract each other to fix the first protective cover.

11. The LED lamp according to claim 4, wherein the switching mechanism comprises a third switching mechanism, the third switching mechanism comprising a protective frame and a second hinge, the protective frame being mounted on the driving module and surrounding a periphery of the first plug-in terminal; and
the connector is hinged to the protective frame through the second hinge, allowing the connector to flip and switch between a turned-off state and a turned-on state; when the connector is in the turned-off state, the second plug-in terminal contacts the first plug-in terminal to conduct the driving module with the light source; when the connector flips to the turned-on state, the first plug-in terminal is exposed and is engaged with the third plug-in terminal of the emergency module, enabling the emergency module to supply power to the driving module.

12. An LED lamp, comprising:
a light source, a driving module for driving the light source to operate, and a power supply module for supplying power to the driving module, the power supply module being electrically connected to the driving module, and the driving module having a first plug-in terminal;
a connector having a second plug-in terminal; and
an emergency module having a third plug-in terminal;
wherein the connector and the emergency module are capable of being selectively electrically connected to the driving module so that the LED lamp has at least two operation states:
when the second plug-in terminal of the connector is electrically connected to the first plug-in terminal of the driving module, an electrical connection is established between the driving module and the light source to drive the light source to operate; and
when the third plug-in terminal of the emergency module is in plug-in electrical connection with the first plug-in terminal of the driving module, the emergency module supplies power to the driving module, and the electrical connection between the driving module and the light source is maintained to drive the light source to operate.

13. The LED lamp according to claim 12, further comprising a switching mechanism, the switching mechanism being configured to switch between an electrical connection state of the connector and the driving module, and an electrical connection state of the emergency module and the driving module;
the LED lamp further comprising a reflector, the driving module and the emergency module being detachably mounted on the reflector, the driving module and the emergency module being detachably connected to the reflector through a snap-fit structure.

14. The LED lamp according to claim 13, wherein when the emergency module is electrically connected to the driving module, the connector and the emergency module are engaged through a magnetic structure to position and secure the connector at the emergency module.

15. The LED lamp according to claim 13, wherein the switching mechanism comprises a first switching mechanism, the first switching mechanism comprising a rotating rod and a rotating block, the rotating rod being rotatably arranged within the driving module, the rotating block being arranged at a bottom of the rotating rod; the first plug-in terminal is arranged on the rotating block, and by rotating the rotating rod, the first plug-in terminal is switched between different positions to respectively achieve the electrical connection of the connector and the driving module, and the plug-in electrical connection of the emergency module and the driving module.

16. The LED lamp according to claim 15, wherein the driving module is provided with a rotating groove, the rotating block is located within the rotating groove, and the connector is located on the driving module and within the rotating groove;
the different positions comprise a first position and a second position, and when the first plug-in terminal is in the first position, the first plug-in terminal is located within the rotating groove and in contact with the second plug-in terminal; and
when the first plug-in terminal is in the second position, the first plug-in terminal is switched from inside the rotating groove to outside the rotating groove and is in a state capable of being plugged with the third plug-in terminal.

17. The LED lamp according to claim 16, wherein a mounting groove is further formed on the rotating block, and when the first plug-in terminal is switched to the second position, the mounting groove rotates into the rotating groove to achieve avoidance.

18. The LED lamp according to claim 13, wherein the switching mechanism comprises a second switching mechanism, the second switching mechanism comprising a first protective cover and a first hinge, the first protective cover being hinged to the driving module through the first hinge; and
the connector is arranged on the first protective cover, and the second plug-in terminal rotates and switches with the first protective cover between a closed position and an open position, to switch between a state where the second plug-in terminal is engaged with the first plug-in terminal, and a state where the first plug-in terminal is exposed to be pluggable with the third plug-in terminal.

19. The LED lamp according to claim 18, further comprising a first magnet and a second magnet, the first magnet being arranged on the driving module, and the second magnet being arranged on the first protective cover; and
when the first protective cover rotates to a predetermined open position, the first magnet and the second magnet attract each other to fix the first protective cover.

20. The LED lamp according to claim 13, wherein the switching mechanism comprises a third switching mechanism, the third switching mechanism comprising a protective frame and a second hinge, the protective frame being installed on the driving module and surrounding a periphery of the first plug-in terminal; and
the connector is hinged to the protective frame through the second hinge, allowing the connector to flip and switch between a turned-off state and a turned-on state; when the connector is in the turned-off state, the second plug-in terminal contacts the first plug-in terminal to conduct the driving module with the light source; when the connector flips to the turned-on state, the first plug-in terminal is exposed and is plugged with the third plug-in terminal, enabling the emergency module to supply power to the driving module.
